(19) United States
(12) Patent Application Publication
(10) Pub. No.: US 2007/0163849 A1
(43) Pub. Date: Jul. 19, 2007

(54) Hydraulic vehicle brake equipped with a parking brake device and method for its operation

(75) Inventor: Volker Knop, Ulmen (DE)

Correspondence Address: CONTINENTAL TEVES, INC., ONE CONTINENTAL DRIVE, AUBURN HILLLS, MI, 48326-1581, US

(73) Assignee: Continental Teves AG & Co. oHG

(21) Appl. No.: 10/589,714

(22) PCT Filed: Feb. 17, 2005
(86) PCT No.: PCT/EP05/50703

§ 371 Date: Aug. 17, 2006

(30) Foreign Application Priority Data
Feb. 17, 2004 (DE) 10 2004 007 846.7
Feb. 11, 2005 (DE) 10 2005 006 536.8

(51) Int. Cl. F16D 65/14

(52) U.S. Cl. 188/106 P

(57) ABSTRACT

A hydraulic vehicle brake equipped with a parking brake device, in particular for motor vehicles, includes a brake housing in which at least two hydraulic pressure chambers are provided, with a working pressure chamber that is delimited by a brake piston, and a lockable accumulator pressure chamber. A dual bleeder (2) is provided for simultaneously bleeding the two pressure chambers (7, 9).

To this end, the dual bleeder (2) includes two elements, a bleeder sleeve (30) and a bleeder screw (31). The bleeder sleeve (30) cooperates with a first sealing seat (35), with the result that a hydraulic connection (29) between the two pressure chambers (7, 9) can be separated, while the bleeder screw (31) cooperates with a second sealing seat (36), with the result that at least one of the two pressure chambers (7, 9) can be connected to the atmosphere.

### BACKGROUND OF THE INVENTION

The present invention relates to a hydraulic vehicle brake equipped with a parking brake device, in particular for motor vehicles, including a brake housing in which at least two hydraulic pressure chambers are provided, with one hydraulic pressure chamber being formed by a working pressure chamber that is delimited by a brake piston, while the other hydraulic pressure chamber is formed by a lockable accumulator pressure chamber. Further, the invention relates to a method of operating the hydraulic vehicle brake.

WO 2004/027282 A1 discloses a hydraulic vehicle brake of this type being described in particular by way of FIGS. 3a and 3b. In order to remove gas and air bubbles dissolved in the hydraulic pressure fluid, bleeding of the two pressure chambers is arranged in the prior art hydraulic vehicle. To this end, however, it is necessary to mount a separate bleeder for each pressure chamber, which is considered as disadvantageous in view of the mounting space available.

To perform a parking brake operation, provisions are made in the prior art system that pressure is built up in the working and accumulator pressure chambers preferably by means of independently actuatable pressure generation aggregates. A possible failure of the electrically fed components in the prior art hydraulic vehicle brake would prevent release of the parking brake device.

In view of the above, an object of the invention is to improve a hydraulic vehicle brake with a parking brake device of the type mentioned hereinabove in view of the available mounting space to such effect that the two pressure chambers can be bled in a simple and safe fashion. A second object of the invention involves disclosing a method, which allows realizing an emergency release operation of the parking brake device of a hydraulic vehicle brake during a defect of the electronic unit or the entire electrical supply.

According to the invention, the first-mentioned object is achieved in that a dual bleeder is provided for simultaneously bleeding the two pressure chambers.

In an especially favorable embodiment of the invention, the dual bleeder includes two elements, the first element cooperating with a first sealing seat, with the result that a hydraulic connection between the two pressure chambers can be separated, while the second element cooperates with a second sealing seat, with the result that at least one of the two pressure chambers can be connected to the atmosphere.

In an especially favorable embodiment of the invention, the first sealing seat is formed by a bore in the brake housing that opens into the hydraulic connection.

It is arranged for that the second sealing seat is formed by an axial bore in the first element, which opens into the hydraulic connection.

In a favorable improvement of the subject matter of the invention, the first element is designed as a bleeder sleeve, which is screwed into the brake housing using a thread, while the second element is a bleeder screw that is screwed into the axial bore of the bleeder sleeve.

In a particularly favorable embodiment of the invention, the bleeder sleeve is used as an emergency unlocking element of the parking brake device.

A stop element is designed in the brake housing and prevents unscrewing of the bleeder sleeve.

In another especially favorable design variation of the subject matter of the invention, another axial bore is provided in the bleeder screw and is closed by a dust cap.

The second objective of the invention is achieved according to a method in that an emergency release operation of the parking brake device is carried out implementing at least the following steps:
I. Manual operation of an emergency unlocking element in such a manner that the working pressure chamber is in hydraulic communication with the accumulator pressure chamber;
II. Pressure buildup in the working pressure chamber and in the accumulator pressure chamber exclusively by operation of the brake pedal by the driver;
III. Release of the locking engagement of the brake piston.

In a particularly advantageous improvement of the method of the invention, release of the locking engagement is achieved by restoring the effect of a central bearing for a threaded spindle that cooperates with the brake piston.

The invention will be described in detail hereinbelow by way of an embodiment, making reference to the accompanying drawings.

### BRIEF DESCRIPTION OF THE DRAWINGS

In the drawings:

FIG. 1 is an axial cross-sectional view of a hydraulic vehicle brake in which the invention can be implemented;

FIG. 2 is a partial view a design of the hydraulic brake of the invention.

### DETAILED DESCRIPTION OF THE DRAWINGS

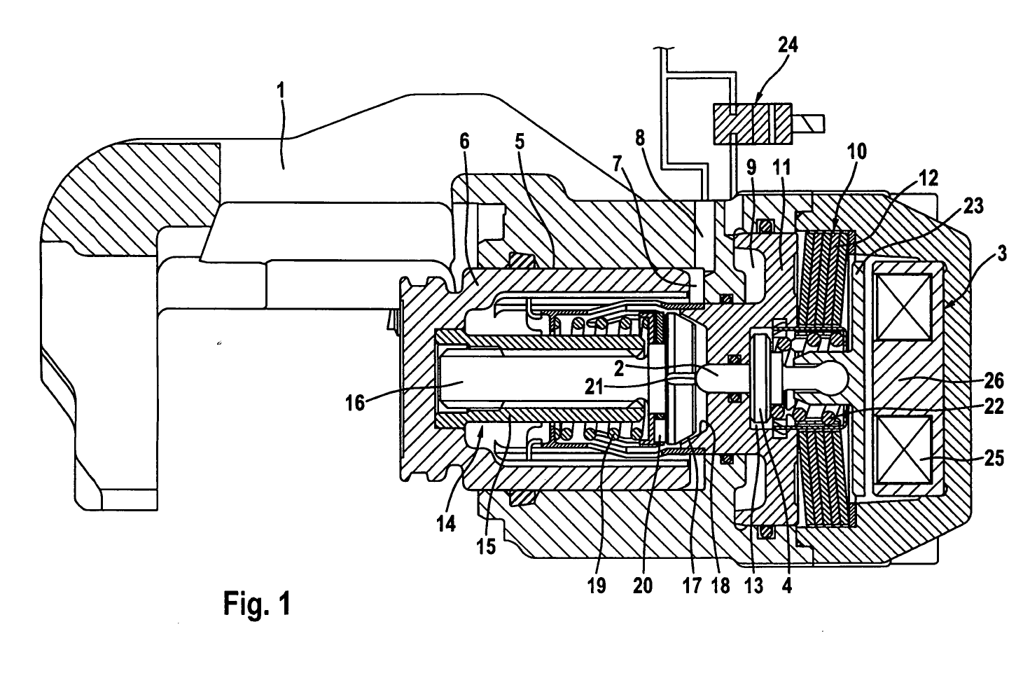

The design of the hydraulic vehicle brake of the invention shown in FIG. 1 includes a brake housing 1 straddling the outside edge of a brake disc (not shown) and two brake pads (likewise not shown). The brake housing 1 forms on its inside surface a brake cylinder 5 receiving a brake piston 6 in an axially displaceable manner. By way of a hydraulic port 8, brake fluid can be fed into the working pressure chamber 7 formed between brake cylinder 5 and brake piston 6, whereby brake pressure develops that displaces the brake piston 6 axially towards the brake disc. This will urge the brake pad facing the brake piston 6 against the brake disc, whereupon the brake housing 1, as a reaction, displaces in the opposite direction and thereby urges also the other brake pad against the brake disc.

As can be taken from FIG. 1 in addition, an energy accumulator 10 is arranged at the side of the brake housing 1 remote from the brake piston 6. Energy accumulator 10 is mainly comprised of a hydraulic accumulator pressure chamber 9, an accumulator piston 11 delimiting the accumulator pressure chamber 9, as well as a spring element 12 being designed as an assembly of cup springs and supported at the accumulator piston 11 in the example shown. The energy stored in the energy accumulator 10 acts on the brake piston 6 during a parking brake operation, as will be explained in more detail in the following. It is hereby achieved that the application force that acts on the brake pads is almost independent of thermally induced changes in length in the area of the brake housing 1.

A spindle drive or a threaded-nut/spindle assembly 14, respectively, forms a locking device, which is necessary for realizing a parking brake function in the design illustrated in FIG. 1. The mentioned threaded-nut/spindle assembly 14 comprises a threaded nut 15 and a spindle 16 being in connection with each other by means of a non-self-locking thread. In this arrangement, the threaded nut 15 is rigidly connected to the brake piston 6, while the spindle 16 at its end remote from the brake piston 6 includes a preferably conical first friction surface 17, which can be moved into and out of engagement with a second friction surface 18 that is arranged in the accumulator piston 11 in a non-rotatable fashion. For this purpose, a force-transmitting element 27 is provided, which is received in a cylindrical stepped bore 13 in the accumulator piston 11, projects through the latter and forms a central bearing 21 for the spindle 16. After a relative movement of the force-transmitting element 27 in relation to the accumulator piston 11, the function of the central bearing 21 is omitted, and the two friction surfaces 17, 18 are in engagement with each other, as will be explained in more detail hereinbelow. Further, a spring 19 supported on the brake housing 1 biases the spindle 16 in the direction of the second friction surface 18 or the central bearing 21, respectively, by the intermediary of an axial bearing 20.

The first design of the hydraulic vehicle brake of the invention is illustrated in FIG. 1 in the released condition of the parking brake. To lock the parking brake, a pressure generator, not referred to in detail, is used to build up hydraulic pressure initially both in the working pressure chamber 7 and in the accumulator pressure chamber 9. To this end, an electrically operable valve, which is preferably configured as a normally closed (NC) valve 24 must adopt its open operating position. The brake piston 6 displaces to the left in the drawing as a reaction to the pressure buildup in the working pressure chamber 7, while the accumulator piston 11 is displaced to the right in the drawing in opposition to the action of force of the preloaded spring element 12. The spring element 12 is compressed in this action. As this occurs, the accumulator piston 11 entrains the force-transmitting element 27 in that a collar 4 designed at the force-transmitting element 27 is supported at the transition between small and large diameter of the stepped bore 13. The accumulator piston 11 and, hence, the force-transmitting element 27 are displaced to the right due to the above-mentioned pressure buildup in the accumulator pressure chamber 9 until an armature plate 23, which is in a force-transmitting connection with the force-transmitting element 27, moves into abutment with an electromagnetic actuator 3. In this action, the spindle 16 continues bearing against the central bearing 21 due to the action of force of the spring 19, with the result that the two friction surfaces 17, 18 cannot become engaged.

Subsequently, the electromagnetic actuator 3 is energized, with the result that the armature plate 23 is arrested by the electromagnetic actuator 3 in its stop position described above. In a following pressure reduction in the working pressure chamber 7 and in the accumulator pressure chamber 9, the brake piston 6 moves to the right in the drawing, while the accumulator piston 11 moves to the left. Arresting of the force-transmitting element 27 enables a relative movement between the force-transmitting element 27 and the accumulator piston 11, whereby the function of the central bearing 21 for the spindle 16 is cancelled and the two friction surfaces 17, 18 are moved into engagement with each other. The biased spring element 12 mentioned hereinabove presses the accumulator piston 11, the spindle 16 blocked due to the friction surfaces 17, 18 being in engagement, the threaded nut 15, and thus the brake piston 6 to the left in the drawing and against the brake disc (not shown), respectively. The vehicle brake is thereby locked in its applied condition. Thereafter the electromagnetic actuator 3 is no more energized, and the armature plate 23 and the force-transmitting element 27, respectively, are no more arrested. The valve 24 adopts its de-energized state, and is hence closed. Thus, the hydraulic vehicle brake does not require energy and hydraulic pressure in order to maintain the locking engagement in the applied condition, which is considered as an advantage.

To release the locking engagement, in turn, hydraulic pressure builds up in the working pressure chamber 7 and, after a corresponding actuation of the NC valve 24, likewise in the accumulator pressure chamber 9. The hydraulic pressure, in turn, would displace the brake piston 6 in FIG. 1 to the left and the accumulator piston 11 to the right. However, it is sufficient for releasing the parking brake when the accumulator piston 11 is relieved from load. Another spring element 22, which moves the force-transmitting element 27 into abutment at the transition between small and large diameter of the stepped bore 13, urges the force-transmitting element 27 in the direction of the spindle 16 and pushes the engaged friction surfaces 17, 18 open, when the accumulator piston 11 is relieved from load in a corresponding manner. Thereafter, the force-transmitting element 27 forms a central bearing 21 for the spindle 16 again.

As FIG. 1 shows, the above-mentioned further spring element 22 additionally takes care that in the event of a service brake operation, where only the working pressure chamber 7 is acted upon by pressure, the force-transmitting element 27 is not displaced because it is biased by the further spring element 22 in opposition to the action of force of the hydraulic pressure in the working pressure chamber 7. The accumulator piston 11 is neither displaced in a service brake operation because the effective diameter of the accumulator piston 11 close to the working pressure chamber 7 is smaller than the effective diameter of the brake piston 6. Also, the spring element 12 designed with a preloading force defined by construction acts in opposition to the pressurization in the working pressure chamber 7, what likewise prevents displacement of the accumulator piston 11 during a service brake operation.

The coil 25 of the electromagnetic actuator 3 fulfils the function of a sensor for sensing the position of the armature plate 23, which position allows detecting whether locking of the vehicle brake is or is not possible. In addition, especially the action of the armature plate 23 striking against the electromagnetic actuator 3 is a signal for the pressure generator (not referred to in detail) to terminate the pressure buildup for performing a parking brake operation in the pressure chambers 7, 9. In order to determine the position of the armature plate in a reliable manner, the change of inductance of the coil 25 of the electromagnetic actuator 3, being caused by the movements of the armature plate, is defined. This is done in that voltage pulses are applied to the coil 25. The variation of the current that flows through the coil 25 is simultaneously determined. This current variation indicates the position of the armature plate 23 and, thus, the position of the force-transmitting element 27. As the position of the armature plate 23 changes, the variation of the current that flows through the coil 25 will change as well. The change of inductance of the coil 25 mainly depends on the size of the slot between the armature plate 23 and the iron yoke 26 of the electromagnetic actuator 3.

It is of course also feasible to employ a sensor element for sensing the armature plate position or for determining the position of the force-transmitting element 27, respectively. This sensor element can be designed as a Hall sensor or as a magneto-resistive sensor element, both allowing non-contact sensing.

Various pressure generation aggregates, being preferably actuatable by independent force, are used for pressure buildup both in the working pressure chamber 7 and in the accumulator pressure chamber 9. Thus, it is possible to use a hydraulic pump, for example. The use of an actuating unit with an independently actuatable brake booster and a master brake cylinder connected downstream of the brake booster is also feasible. Alternatively, however, a pressure generating means operable by the driver can be used as well.

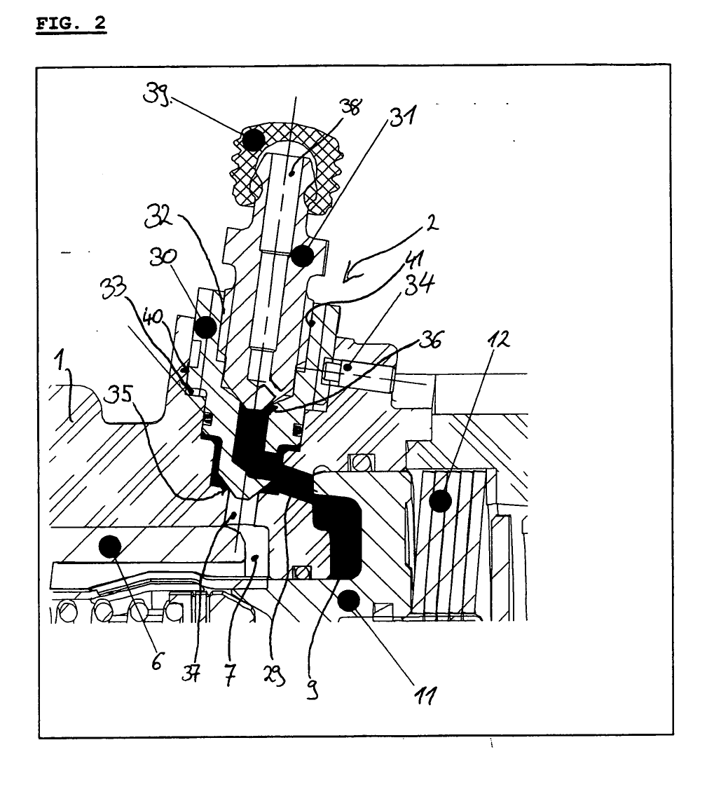

A bleeding action is required to remove enclosed air and gas bubbles from the vehicle brake described by way of FIG. 1 and the hydraulic line system connected thereto. As both pressure chambers 7, 9 must be bled, the invention suggests using a dual bleeder 2 for simultaneously bleeding the two pressure chambers 7, 9. The dual bleeder 2 is shown in FIG. 2 and mounted on the side of the brake housing 1 that is opposite to the hydraulic port 8 as described by way of FIG. 1. As shown in FIG. 2, the dual bleeder 2 has a dual design. A bleeder sleeve 30 is screwed into a bore 33 in the brake housing 1 using a thread 40. The bleeder sleeve 30, in turn, has an axial bore 32 into which a bleeder screw 31 is screwed using another thread 41.

The mode of operation of the dual bleeder 2 will be explained in detail in the following: The bleeder sleeve 30 screwed into the brake housing 1 cooperates with a first sealing seat 35 in such a fashion that the working pressure chamber 7, which has been described already by way of FIG. 1, is connectable to the accumulator pressure chamber 7. To this end, a bore 37 extends from the working pressure chamber 9 in an almost radial direction and forms the first sealing seat 35 in addition. Moreover, there is a hydraulic connection 29 in the brake housing 1, which opens into the accumulator pressure chamber 9, on the one hand, and into the bore 37 connected to the working pressure chamber 7, on the other hand. In this arrangement, the hydraulic connection 27 including the bore 37 described above is adapted to be connected and isolated by the cooperation of the bleeder sleeve 30 with the first sealing seat 35. This allows a hydraulic connection and separation between the working pressure chamber 7 and the accumulator pressure chamber 9.

As illustrated in FIG. 2, the axial bore 32 that is designed in the bleeder sleeve 30 opens into the hydraulic connection 29 that has been described above. This axial bore 32 forms a second sealing seat 36 which cooperates with the bleeder screw 31 screwed into the axial bore 32. The bleeder screw 31 includes another axial bore 38 that is closed by a dust cap 39. If the bleeder screw 31 does not bear against the second sealing seat 36 described hereinabove, the hydraulic connection 29 and, thus, at least the accumulator pressure chamber 9 communicates with the atmosphere. If the working pressure chamber 7 is simultaneously connected hydraulically to the accumulator pressure chamber 9, as described above, likewise the working pressure chamber 7 is connected to the atmosphere.

In a bleeding operation of the hydraulic vehicle brake, initially, the bleeder sleeve 30 is unscrewed until a stop element 34 provided in the brake housing 1 prevents continued unscrewing. This will initially interconnect the working pressure chamber 7 and the accumulator pressure chamber 9. Subsequently, the bleeder screw 31 is screwed thereon and the dust cap 39 removed, what connects the two pressure chambers 7, 9 to the atmosphere, as has been described above. Thereafter the SG valve 24 is energized, i.e. opened, which has been mentioned with respect to FIG. 1. A subsequent pressure buildup of the pressure generation aggregate, which is not described in detail, supplies the hydraulic pressure fluid both through the working pressure chamber 7 and through the accumulator pressure chamber 9 via the hydraulic connection 27 and the additional axial bore 38 provided in the bleeder screw 31 out of the hydraulic vehicle brake or out of the hydraulic brake system, respectively. Any air or gas bubbles that might exist in the pressure fluid are expelled in this operation. The bleeder screw 31 is screwed down again thereafter, with the result that the pressure chambers 7, 9 no longer communicate with the atmosphere. Subsequent thereto, the bleeder sleeve 30 is screwed down again as well, what separates the connection between the two pressure chambers 7, 9.

In addition, the bleeder sleeve 30 is used as an emergency unlocking element of the parking brake device, as will be explained in detail in the following. When electric energy fails, it is impossible to open the SG valve 24 mentioned with respect to FIG. 1, and the above-described unlocking operation of the vehicle brake is prevented. The same applies if the SG valve 24 is prevented by a defect from assuming its open operating position. When an electrically operated pressure generation aggregate is employed in order to perform a locking and unlocking operation of the vehicle brake, an unlocking operation is likewise no longer possible in the event of failure of the electric energy or a defect of the pressure generation aggregate. To be able to move the motor vehicle in spite of these defects, an emergency release operation is required. To this end, the bleeder sleeve 30 is first of all unscrewed until the stop element 34 prevents a continued screwing action. This provides a hydraulic communication between the working pressure chamber 7 and the accumulator pressure chamber 9, as has been described before. A pressure buildup by the driver, meaning due to application of the brake pedal by the driver, acts in both pressure chambers 7, 9 due to the opened connection between the working pressure chamber 7 and the accumulator pressure chamber 9. As this occurs, the brake piston in FIG. 1 displaces to the left and the accumulator piston 11 is additionally relieved from load, as is done in the unlocking operation that has been described with regard to FIG. 1. The spring element 22 shown in FIG. 1 urges the force-transmitting element 27 in the direction of the spindle 16 and pushes the engaged friction surfaces 17, 18 open. The force-transmitting element 27 will subsequently form a central bearing 21 for the spindle 16 again, and the motor vehicle can be moved without being braked. Thereafter the bleeder screw 30 should be closed again, whereby the two pressure chambers 7, 9 are isolated again.

1.-10. (canceled)

11. A hydraulic vehicle brake equipped with a parking brake device, including a brake housing (1) in which at least two hydraulic pressure chambers (7, 9) are provided, with one hydraulic pressure chamber being formed by a working pressure chamber (7) that is delimited by a brake piston (6), while the other hydraulic pressure chamber is formed by a lockable accumulator pressure chamber (9),
wherein a dual bleeder (2) is provided for simultaneously bleeding the two pressure chambers (7, 9).

12. The hydraulic vehicle brake as claimed in claim 11,
wherein the dual bleeder (2) includes two elements (30, 31), the first element (30) cooperating with a first sealing seat (35), with the result that a hydraulic connection (29) between the two pressure chambers (7, 9) can be separated, while the second element (31) cooperates with a second sealing seat (36), with the result that at least one of the two pressure chambers (7, 9) can be connected to the atmosphere.

13. The hydraulic vehicle brake as claimed in claim 12,
wherein the first sealing seat (35) is formed by a bore (37) in the brake housing (1) that opens into the hydraulic connection (29).

14. The hydraulic vehicle brake as claimed in claim 12,
wherein the second sealing seat (36) is formed by an axial bore (32) in the first element (30), which opens into the hydraulic connection (29).

15. The hydraulic vehicle brake as claimed in claim 12,
wherein the first element (30) is designed as a bleeder sleeve (30) that is screwed into the brake housing (1) using a thread (40), the bleeder sleeve having an axial bore (32), and wherein the second element (31) is realized by a bleeder screw (31) that is screwed into the axial bore (32) of the bleeder sleeve (30).

16. The hydraulic vehicle brake as claimed in claim 15,
wherein the bleeder sleeve (30) serves as an emergency unlocking element of the parking brake device.

17. The hydraulic vehicle brake as claimed in claim 15,
wherein a stop element (34) is designed in the brake housing (1) and prevents unscrewing of the bleeder sleeve (30).

18. The hydraulic vehicle brake as claimed in claim 15,
wherein another axial bore (38) being closed by a dust cap (39) is provided in the bleeder screw (31).

19. A method for the operation of a hydraulic vehicle brake equipped with a parking brake device, in particular for motor vehicles, including a brake housing (1) in which at least two hydraulic pressure chambers (7, 9) are provided, with one hydraulic pressure chamber being formed by a working pressure chamber (7) that is delimited by a brake piston (6), while the other hydraulic pressure chamber is formed by a lockable accumulator pressure chamber (9), with an unlocking element dis[posed between the working pressure chamber and the accumulator pressure chamber,
wherein an emergency release operation of the parking brake device is carried out implementing at least the following steps:
I. Manual operation of an emergency unlocking element (30) in such a manner that the working pressure chamber (7) is in hydraulic communication with the accumulator pressure chamber (9);
II. Pressure buildup in the working pressure chamber (7) and in the accumulator pressure chamber (9) exclusively by operation of the brake pedal by the driver;
III. Release of the locking engagement of the brake piston (6).

20. The method as claimed in claim 19 for a hydraulic vehicle brake including a threaded spindle (16), capable of cooperating with the brake piston (6), and a central bearing (21),
wherein the locking engagement is released by restoring an effect of the central bearing (21) for the threaded spindle (16) that cooperates with the brake piston (6).
